(19) United States
(12) Patent Application Publication
(10) Pub. No.: US 2021/0174299 A1
(43) Pub. Date: Jun. 10, 2021

(54) METHOD, SYSTEM AND DEVICE FOR COLLECTING SALES INFORMATION OF COMMODITIES IN CABINET, AND STORAGE MEDIUM

(71) Applicant: Shanghai Clobotics Technology Co., Ltd., Shanghai (CN)

(72) Inventors: Xing Tong, Shanghai (CN); Liang Sang, Shanghai (CN); Yan Ke, Shanghai (CN); Peizhao Li, Shanghai (CN)

(21) Appl. No.: 17/116,361

(22) Filed: Dec. 9, 2020

(30) Foreign Application Priority Data
Dec. 9, 2019 (CN) 2019112520866
Sep. 11, 2020 (CN) 2020109552578

(51) Int. Cl. G06Q 10/08; G06N 20/00

(52) U.S. Cl. CPC G06Q 10/0875; G06N 20/00

(57) ABSTRACT

The present disclosure relates to the field of image processing technology, in particular to a method, system and device for collecting sales information of commodities in a cabinet, and a storage medium. Steps of the method include: successively acquiring pictures of the cabinet with the commodities placed therein in chronological order; acquiring commodity information on the former picture of every two adjacent cabinet pictures; successively adjusting every two adjacent cabinet pictures; comparing the corresponding commodity areas in every two adjacent cabinet pictures after the adjustment; and in the presence of different image contents, acquiring the number of commodity areas with different image contents and corresponding commodity information on the former picture. In the present disclosure, the traditional method of manually collecting commodity sales information is changed to an automatic collection method, thereby greatly improving the collection efficiency of commodity sales information, and reducing manual labor intensity, and also dynamic changes of commodity sales can be known in real time.

### FIELD OF THE INVENTION

The present disclosure relates to the field of image processing technology, in particular to a method, system and device for collecting sales information of commodities in a cabinet, and a storage medium.

### BACKGROUND

In life, people frequently buy commodities from shelves and refrigerated cabinets in supermarkets. In this mode of purchase, customers can easily find commodities they want to buy, and also can freely decide whether to buy. After the customers purchase the corresponding commodities, corresponding vacant areas will appear at positions of the sold commodities, unless a working person in the supermarket makes arrangement.

To ensure a continuous supply of commodities and know the sales of the commodities, a tally clerk in the supermarket will make an inventory of the commodities in the shelves and refrigerated cabinets regularly and replenish the stock in time to ensure a sufficient supply of commodities.

### SUMMARY OF THE INVENTION

An aspect of the present disclosure provides a method for collecting sales information of commodities in a cabinet. The method includes the following steps:

successively acquiring pictures of the cabinet with the commodities placed therein in chronological order;

acquiring commodity information on the former picture of every two adjacent cabinet pictures;

successively adjusting every two adjacent cabinet pictures, so that photographing angles and positions of commodities in corresponding commodity areas of the two adjacent cabinet pictures are consistent;

comparing the corresponding commodity areas in every two adjacent cabinet pictures after the adjustment to determine whether different image contents are present in the corresponding commodity areas; and

in the presence of different image contents, acquiring the number of commodity areas with different image contents and corresponding commodity information on the former picture.

In an embodiment, the step of successively adjusting every two adjacent cabinet pictures, so that photographing angles and positions of commodities in corresponding commodity areas of the two pictures are consistent includes:

acquiring feature points on different commodities in the two adjacent cabinet pictures;

pairing the feature points in the two adjacent cabinet pictures to calculate a homography matrix; and

in the order of photographing time, performing a perspective transformation on the latter picture of the two pictures according to the homography matrix, to obtain two pictures in which the photographing angles and the positions of the commodities in the corresponding commodity areas are consistent.

In an embodiment, the step of successively adjusting every two adjacent cabinet pictures of a number of pictures, so that photographing angles and positions of commodities in corresponding commodity areas of the two pictures are consistent includes:

in the order of photographing time, detecting commodities in the former picture of the two adjacent cabinet pictures to provide a first marker box for the commodities in the former picture;

using a template matching method, marking the latter picture with a second marker box corresponding to the first marker box;

using center points of the two corresponding marker boxes as corresponding feature points;

calculating a homography matrix by using the corresponding feature points; and

performing a perspective transformation on the latter picture of the two adjacent pictures by using the homography matrix to obtain two pictures in which the photographing angles and the positions of the commodities in the corresponding commodity areas are consistent.

In an embodiment, the step of comparing the corresponding commodity areas in every two adjacent cabinet pictures after the adjustment to determine whether different image contents are present at positions in the corresponding commodity areas includes:

performing channel dimension stacking on every two adjacent cabinet pictures after the adjustment to obtain an image matrix in which the corresponding commodity areas coincide; and

inputting the image matrix into a recognition model capable of recognizing image contents of the corresponding commodity areas in the image matrix, to determine whether the image contents of the corresponding commodity areas are same.

In an embodiment, a method for training the recognition model includes the following steps:

successively acquiring, in chronological order, a plurality of simulated pictures that simulate changes in the sales of the commodities in the cabinet;

successively adjusting every two adjacent pictures of the plurality of simulated pictures, so that photographing angles and positions of commodities in corresponding commodity areas of the two pictures are consistent;

performing marking in the former picture arranged in chronological order of every two adjacent simulated pictures after the adjustment to mark an area where a sold commodity is simulated;

performing channel dimension stacking on every two adjacent simulated pictures after the marking to obtain a simulated image matrix in which the corresponding commodity areas coincide; and

training a model by using the simulated image matrix to obtain a recognition model capable of recognizing image contents of the corresponding commodity areas.

In an embodiment, the step of acquiring commodity information on the former picture of every two adjacent cabinet pictures includes:

detecting all commodities on the former picture of every two adjacent cabinet pictures;

performing cutout processing on an area occupied by each commodity on the former picture, so that the area occupied by each commodity forms an independent cutout image; and

recognizing the cutout image to obtain commodity information in each cutout image in one-to-one correspondence with each commodity on the former picture.

In an embodiment, the method further includes:

inputting the former picture of every two adjacent cabinet pictures into a pre-trained repeated area detection model to detect a repeated area in the former picture; and

deducting commodity information and quantity that are double-counted in the repeated area to obtain the number of commodity areas with different image contents and corresponding commodity information after deduplication.

Another aspect of the present disclosure provides a system for collecting sales information of commodities in a cabinet. The system for collecting sales information of commodities in a cabinet is used for implementing the steps of the method for collecting sales information of commodities in a cabinet as described above. The system includes:

a data acquisition module for successively acquiring pictures of the cabinet with the commodities placed therein in chronological order; and

acquiring commodity information on the former picture of every two adjacent cabinet pictures;

a data processing module for successively adjusting every two adjacent cabinet pictures, so that photographing angles and positions of commodities in corresponding commodity areas of the two adjacent cabinet pictures are consistent; and

an image recognition module for comparing the corresponding commodity areas in every two adjacent cabinet pictures after the adjustment to determine whether different image contents are present in the corresponding commodity areas; and

in the presence of different image contents, outputting the number of commodity areas with different image contents and corresponding commodity information on the former picture.

Yet another aspect of the present disclosure provides a device for collecting sales information of commodities in a cabinet. The device for collecting sales information of commodities in a cabinet includes:

a memory for storing a computer program; and

a processor for implementing the steps of the method for collecting sales information of commodities in a cabinet as described above when executing the computer program.

A last aspect of the present disclosure provides a computer readable storage medium. The computer readable storage medium stores a computer program which, when executed by a processor, implements the steps of the method for collecting sales information of commodities in a cabinet as described above.

In the method, system and device for collecting sales information of commodities in a cabinet and the storage medium provided by the present disclosure, the traditional method of manually collecting commodity sales information is changed to an automatic collection method, thereby greatly improving the collection efficiency of commodity sales information, and reducing manual labor intensity, and also dynamic changes of commodity sales can be known in real time.

On the other hand, the present disclosure can also provide reliable picture comparison data by different picture comparison methods, and accurately distinguish between different situations where commodities are for sale and where commodities are sold.

Finally, the present disclosure also provides a method for training an image recognition model, which can more effectively improve the recognition speed and accuracy of sales information of commodities on shelves and refrigerated cabinets.

### BRIEF DESCRIPTION OF THE DRAWINGS

The drawings exemplarily illustrate embodiments and constitute a part of the specification, and together with the word description of the specification, serve to explain exemplary implementations of the embodiments. The illustrated embodiments are for illustrative purposes only and do not limit the scope of the claims. In all drawings, same reference signs denote similar but not necessarily same elements.

FIG. 1 is a flow diagram of steps of a method for collecting sales information of commodities in a cabinet illustrated in an embodiment of the present disclosure;

FIG. 2 is a flow diagram of steps of a method for adjusting pictures provided in an embodiment of the present disclosure;

FIG. 3 is a flow diagram of steps of a method for adjusting pictures provided in an embodiment of the present disclosure;

FIG. 4 is a schematic diagram of steps of a method for recognizing cabinet pictures provided in an embodiment of the present disclosure;

FIG. 5 is a schematic diagram of steps of a method for training a recognition model provided in an embodiment of the present disclosure;

FIG. 6 illustrates preferred method steps for acquiring commodity information in the former picture of two adjacent cabinet pictures provided in an embodiment of the present disclosure;

FIG. 7 is a flow diagram of preferred method steps for deducting double-counted commodities provided in an embodiment of the present disclosure;

FIG. 8 is a modular connection diagram of a system for collecting sales information of commodities in a cabinet provided in an embodiment of the present disclosure;

FIG. 9 is a structural diagram of a device for collecting sales information of commodities in a cabinet provided in an embodiment of the present disclosure; and

FIG. 10 is a structural diagram of a computer readable storage medium provided in an embodiment of the present disclosure.

### DETAILED DESCRIPTION OF THE EMBODIMENTS

According to the above description, in life, people frequently buy commodities from shelves and refrigerated cabinets in supermarkets.

To ensure a continuous supply of commodities and know the sales of the commodities, a tally clerk in the supermarket needs to make an inventory of the commodities in the shelves and refrigerated cabinets regularly and replenish the stock in time. However, performing tallying, making an inventory and forming statistical data, and then replenishing the stock is an arduous task. If all performed manually, it not only consumes much time, but also needs a lot of manpower and material resources. In addition, a method of manually collecting commodity sales information cannot achieve real-time data update, and can only collect the final sales, but dynamic information reflecting the sales cannot be known therefrom.

In the prior art, the above-mentioned manual collection method is commonly used to know sales information of commodities. Therefore, a large amount of operating costs, manpower and material resources are used to collect the sales of commodities. The cost of manual collection continues to rise, but it is still difficult to know dynamic information of commodity sales in real time.

To solve the problems existing in the prior art and change the traditional method of manually collecting commodity sales information to an automatic collection method, the inventor proposes a method for collecting sales information of commodities in a cabinet after creative work. It is to be noted that the method for collecting sales information of commodities in a cabinet provided by the present disclosure can not only be used in large supermarkets, but also be applicable to various convenience stores and even self-service supermarkets and other commercial entities. By using the method for collecting sales information of commodities in a cabinet provided herein, the traditional method of manually collecting commodity sales information is changed to an automatic collection method, thereby greatly improving the collection efficiency of commodity sales information, and reducing manual labor intensity, and also dynamic changes of commodity sales can be known in real time.

A method, system and device for collecting sales information of commodities in a cabinet, and a storage medium proposed in the present disclosure will be further described in detail below in conjunction with the drawings and specific embodiments. Advantages and features of the present disclosure will be more apparent from the claims and the following description. It needs to be noted that the drawings are in a very simplified form and all use imprecise proportions, and only serve to conveniently and clearly explaining the embodiments of the present disclosure in an assistant manner.

It should be understood that the wording in the specification is only used to describe specific embodiments and not intended to limit the present disclosure. Unless otherwise defined, all terms (including technical and scientific terms) used in the specification have meanings as generally understood by those skilled in the art. For brevity and/or clarity, well-known functions or structures are not described in detail.

### Exemplary Description of a Method for Collecting Sales Information of Commodities in a Cabinet

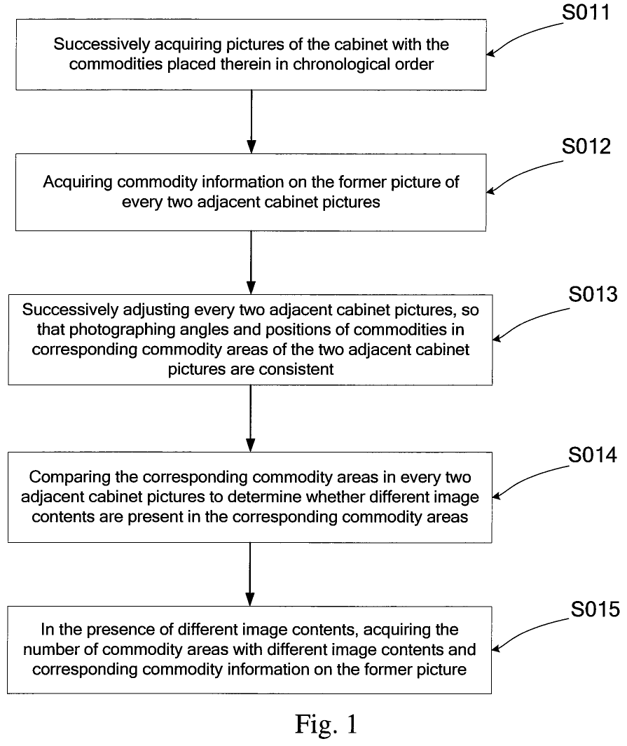

Please refer to FIG. 1, which shows a flow diagram of steps of a method for collecting sales information of commodities in a cabinet in an embodiment of the present disclosure.

In step S011 of the embodiment, pictures of the cabinet with the commodities placed therein are successively acquired in chronological order.

In actual application to a refrigerated cabinet, pictures of the cabinet may be acquired according to opening and closing of a door of the refrigerated cabinet. For example, opening and closing the refrigerated cabinet once generally corresponds to one complete purchasing behavior of a customer. Hence, during closing of the door by the customer, the purchase of a commodity is actually accomplished. Thus, by acquiring a cabinet picture during closing of the door, the commodity after the change on the cabinet can be recorded (after the commodity is taken away by the consumer, there will be a vacancy at the corresponding position, and therefore, the change in the image content caused by the vacancy can just be used in model recognition on the cabinet picture described later to accurately determine whether the commodity is sold).

In step S012, commodity information on the former picture of every two adjacent cabinet pictures is acquired.

It is easy to understand the former picture in step S012 refers to a picture acquired earlier. As to the commodity information referred to in the present disclosure, different contents may be determined according to actual needs. In the present disclosure, the commodity information may be understood as what the commodity in the area is (for example, bottled Coke or canned Coke, 100 ml Coke or Coke in other volume, etc.), the position of the commodity, etc.

In the present disclosure, the commodity sales information is acquired from a change in image contents of the two pictures. Usually, the former picture of the two adjacent pictures compared with each other is used as a reference, because the commodity information in the former picture is more comprehensive than the latter picture (the other picture that is different from the former picture of the two adjacent cabinet pictures). If the image content of a commodity area in the latter picture has a change relative to the former picture (a commodity has changed), then the corresponding areas of the two pictures may be compared to determine whether there is a change in the image contents of the corresponding commodity areas.

When the areas with different image contents are found, it only needs to find the corresponding area in the former picture of the two adjacent cabinet pictures, and recognize the commodity information in the area, to know what the sold commodity is and where it was located. If the number of areas with different image contents is counted, the quantity of sold commodities can be known therefrom.

In step S013, every two adjacent cabinet pictures are successively adjusted, so that photographing angles and positions of commodities in corresponding commodity areas of the two adjacent cabinet pictures are consistent.

It is easy to understand that after the cabinet pictures are adjusted, the sizes and shapes of the two adjacent pictures may tend to be consistent, which is beneficial to comparative analysis of the two pictures. In the present disclosure, the photographing angles and the positions of commodities in corresponding commodity areas being consistent makes it easier for the commodities in the pictures to correspond to each other, which is conducive to more quickly obtaining a comparison result of the two adjacent pictures, thereby improving a response speed of a processing device, which means that the present disclosure can achieve comparison of more pictures within same time, and better adapt to a variety of commodity sales scenarios.

In step S014, the corresponding commodity areas in every two adjacent cabinet pictures after the adjustment are compared to determine whether different image contents are present in the corresponding commodity areas.

With processing in step S013, the commodities in the two adjacent cabinet pictures are compared in step S014 to obtain an accurate comparison result, i.e. whether different image contents are present in the corresponding commodity areas.

It is to be noted that the difference of image contents here may be generally understood as an image color change, or a difference in product shape or the like in the commodity areas. For example, after a commodity in a commodity area is taken away (sold), there will be a vacancy at the position. Due to the presence of the vacancy, the color and product shape at the position are different from those before the commodity is taken away. Just by using such image content changes comparison is performed to determine whether there is a difference in the two adjacent pictures.

The commodity area involved in the present disclosure refers to an area occupied by a commodity in the cabinet picture. When a model is used to detect the commodity in the cabinet picture, the periphery of the commodity will be marked with a closed box to indicate the commodity detected by the model. It is easy to understand that to describe the commodity area specifically, an area with a determined boundary defined by the closed box (generally called a marker box) is usually used as the commodity area.

In step S015, in the presence of different image contents, the number of commodity areas with different image contents and corresponding commodity information on the former picture are acquired.

It can be seen that in the method for collecting sales information of commodities in a cabinet provided by the present disclosure, by collecting picture information of the cabinet, and through operations such as effective processing and comparison on the pictures to collect sales information of commodities in the cabinet, the traditional method of manually collecting commodity sales information is changed to an automatic collection method. Then, the collection efficiency of commodity sales information is greatly improved, and manual labor intensity is reduced, and also dynamic changes of commodity sales can be known in real time.

It is easy to understand that in acquisition of cabinet images, not every picture acquired each time can be kept at the same angle and size. Especially for cabinet with a door such as a refrigerated cabinet, to acquire cabinet pictures of the interior of the refrigerated cabinet in a timely and convenient manner, a tool with a camera is usually installed on the door. This is an inevitable choice for acquiring cabinet pictures. However, in the case of taking a photo when a customer closes the door, it is impossible that photos taken at two times (two door-closing operations may performed by the same customer or different consumers at different moments) are at an identical photographing angle. For example, one photo is taken at a photographing position when the refrigerated cabinet is closed to 50°, and the other photo is taken at a photographing position when the refrigerated cabinet is closed to 40°. As the positions and angles of the two photographing operations cannot be identical, there may be great changes in the sizes and angles of a commodity at the same position in the cabinet pictures acquired at two times. The images need to be adjusted so that the photographing angles and the sizes of the same commodity at corresponding positions of the two adjacent pictures tend to be consistent.

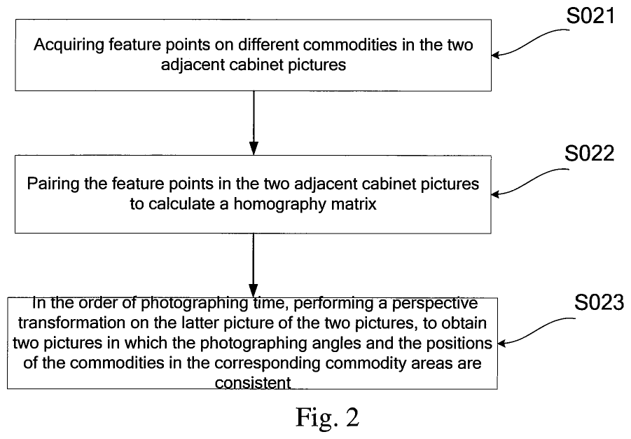

For the adjustment of the two adjacent pictures, in an embodiment of the present disclosure, a preferred implementation of “adjustment of the acquired picture” is also described. A flow diagram of steps of a method for adjusting the pictures provided in the embodiment is illustrated in FIG. 2.

In step S021 of this embodiment, feature points on different commodities in the two adjacent cabinet pictures are acquired.

The feature points on different commodities in step S021 refer to feature points abstracted based on detected commodities, and differ from traditional feature points which are based on the entire areas of the whole pictures without distinguishing between feature points formed by commodities areas and feature points formed by non-commodity areas. In the embodiment, since all feature points are distributed on the commodities, while non-commodity areas have no feature points, the number of feature points may be reduced, and as compared with the traditional method of acquiring feature points of entire pictures (feature points on commodities and non-commodities), the amount of calculation can be greatly reduced and the calculation efficiency is improved, and furthermore, background noise and other contents that are unimportant to the present disclosure are filtered out in the process of paring feature points, thereby providing an effective feature point pairing relationship for a subsequent alignment operation of the commodity areas, such that the positions of the commodities in the corresponding commodity areas and the photographing angles on the final two pictures tend to be more consistent.

In step S022, the feature points in the two adjacent cabinet pictures are paired to calculate a homography matrix.

The purpose of the matching operation here is to build a correspondence relationship between pixels in the two pictures. Once there is the correspondence relationship, a skilled person may get the homography matrix by using a mathematical method. The homography matrix in the embodiment refers to a correspondence relationship between two different coordinate systems. With the homography matrix, some changes and adjustments may be made conveniently to the images, which is beneficial to reduction of the amount of calculation and the time of adjusting the pictures.

In step S023, in the order of photographing time, a perspective transformation is performed on the latter picture of the two pictures according to the homography matrix, to obtain two pictures in which the photographing angles and the positions of the commodities in the corresponding commodity areas are consistent.

The perspective transformation refers to a transformation that uses the condition that the perspective center, image point and target point are collinear, to rotate, according to the law of perspective rotation, the shadow surface (perspective surface) around the trace (perspective axis) by an angle to destroy the original projected light beam while still keeping the projection geometry unchanged on the shadow surface. With the perspective transformation operation, two pictures in which the photographing angles and the positions of the commodities in the corresponding commodity areas are consistent can be quickly obtained.

The position of a commodity mentioned in the present disclosure refers to a relative position between a certain commodity and other commodities in the cabinet picture.

It is easy to understand that by acquiring the feature points on multiple different commodities in each picture, and pairing the feature points on the two pictures to obtain the homography matrix, the images may be subjected to shape change processing in terms of the mathematical matrix, so that the two pictures may be effectively brought into a state in which the photographing angles and the positions of the commodities in the corresponding commodity areas are consistent. In the adjustment, a corresponding method of SIFT (scale-invariant feature transform) may be used for processing to improve the processing effect of the pictures, so that the influence of background and irrelevant features on subsequent results is eliminated to facilitate subsequent recognition, and the accuracy and efficiency of adjustment are improved.

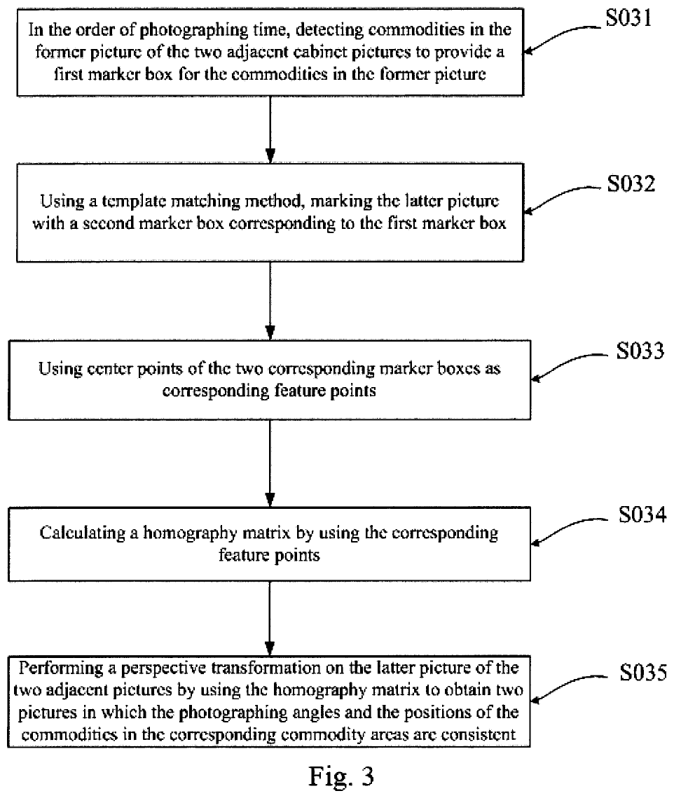

In an embodiment of the present disclosure, another preferred implementation of “adjustment of the acquired picture” is also described. The preferred implementation provided in the embodiment differs from the implementation provided in the previous embodiment in that it needs to recognize commodities in the pictures and mark the commodities, which can ensure all commodities in the two pictures can be accurately corresponded to improve the consistency of the corresponding commodities in the two pictures. A flow diagram of steps of a method for adjusting the pictures provided in the embodiment is illustrated in FIG. 3.

In step S031, in the order of photographing time, commodities in the former picture of the two adjacent cabinet pictures are detected to provide a first marker box for the commodities in the former picture.

In step S032, using a template matching method, the latter picture is marked with a second marker box corresponding to the first marker box.

Template matching is one of the most primitive and most basic pattern recognition methods. It studies where the pattern of a particular object is located in an image and then identifies the object. This involves matching. A template is a known small image, and template matching is to search for a target in a large image. The target to be looked for is known to be in the large image, and the target has the same size, direction and image elements as the template. By using a certain algorithm, the target may be found in the image and its coordinate position may be determined.

In step S033, center points of the two corresponding marker boxes are used as corresponding feature points.

In step S034, a homography matrix is calculated by using the corresponding feature points.

In step S035, a perspective transformation is performed on the latter picture of the two adjacent pictures by using the homography matrix to obtain two pictures in which the photographing angles and the positions of the commodities in the corresponding commodity areas are consistent.

It can be seen that the present disclosure not only provides different picture adjusting methods, but also can adjust the two adjacent pictures to the same photographing angle by any of the two different picture adjusting methods, and the positions of the commodities in the corresponding commodity areas tend to be more consistent.

For example, in adjusting the acquired two adjacent pictures in a refrigerated cabinet, the latter cabinet picture in chronological order may be adjusted to achieve a photographing effect of the former cabinet picture.

It is to be noted that a template matching method may be used to mark the commodities in the other picture here. The template matching method involved here is one of the most primitive and most basic pattern recognition methods. It studies where the pattern of a particular object is located in an image and then identifies the object. This involves matching. It is the most basic and most commonly used matching method in image processing.

In addition, to collect the commodity sales information (whether a commodity at a corresponding position has changed) in the acquired cabinet pictures, the present disclosure also provides an image recognition method.

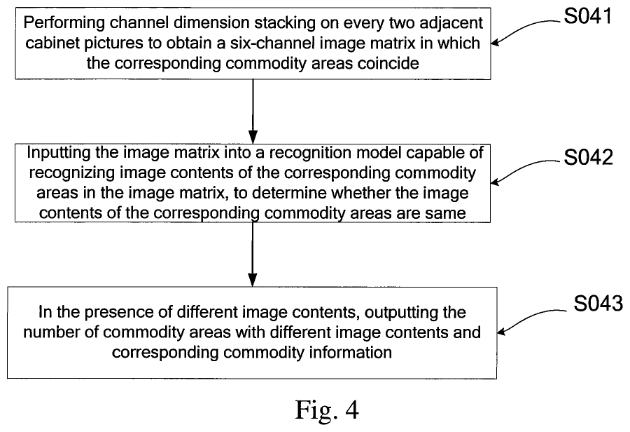

Referring to FIG. 4, which is a schematic diagram of steps of a method for recognizing cabinet pictures provided in an embodiment of the present disclosure.

In step S041 of the embodiment, channel dimension stacking is performed on every two adjacent cabinet pictures after the adjustment to obtain a six-channel (RGBRGB) image matrix in which the corresponding commodity areas coincide. Under the conventional definition, three channels may be denoted as RGB, and six channels in the embodiment may be denoted as RGBRGB. It is easy to understand that the channel dimension stacking in the present disclosure means that two image matrices are stitched in the channel dimension to form one matrix, while maintaining the correspondence in the image bit relationship.

In this step, the stacked two pictures are aligned (the corresponding commodity areas coincide), so that a subsequent recognition model directly recognizes whether there are differences in the two pictures at a time. Obviously, this is different from the conventional operation in which two pictures are merely subjected to channel stacking without requiring alignment, and the conventional solution cannot achieve recognition of two pictures at a time.

In step S042 of the embodiment, the image matrix is input into a recognition model capable of recognizing image contents of the corresponding commodity areas in the image matrix, to determine whether the image contents of the corresponding commodity areas are same.

In step S043 of the embodiment, in the presence of different image contents, the number of commodity areas with different image contents and corresponding commodity information are output.

It can be seen that by using the method for recognizing cabinet pictures provided by the present disclosure, whether different image contents are present in the corresponding commodity areas of the two adjacent cabinet pictures can be recognized accurately, and the efficiency and accuracy of image recognition are further improved.

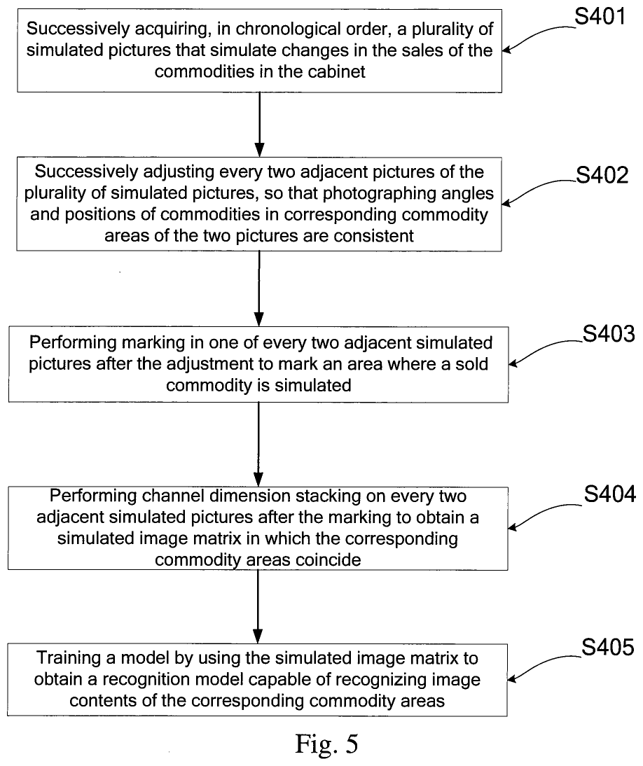

Next, the embodiment further provides a method for training the recognition model. Please refer to a schematic diagram of steps of the method for training a recognition model illustrated in FIG. 5.

In step S401 of the embodiment, a plurality of simulated pictures that simulate changes in the sales of the commodities in the cabinet are successively acquired in chronological order.

In step S402 of the embodiment, every two adjacent pictures of the plurality of simulated pictures are successively adjusted, so that photographing angles and positions of commodities in corresponding commodity areas of the two pictures are consistent.

In step S403 of the embodiment, marking is performed in one (or the former picture arranged in chronological order) of every two adjacent simulated pictures after the adjustment to mark an area where a sold commodity is simulated.

In step S404 of the embodiment, channel dimension stacking is performed on every two adjacent simulated pictures after the marking to obtain a simulated image matrix in which the corresponding commodity areas coincide.

In step S405 of the embodiment, a model is trained by using the simulated image matrix to obtain a recognition model capable of recognizing image contents of the corresponding commodity areas.

As we all know, in the case of training a recognition model by an existing method, usually each picture taken separately (different from channel dimension stacking of two pictures in the embodiment of the present disclosure) is input into a network model for training. Although the recognition model trained by such a method can achieve the effect of recognizing a target in the image, however, in the face of the problem solved in the embodiment that whether there are differences in the corresponding areas in the two pictures can be directly determined, obviously it cannot be solved directly by using the existing training method. The traditional method uses a single picture to train the model, so even if two pictures input to the recognition model for recognition are combined, the effect of the recognition model trained by using the method described in the embodiment cannot be achieved. By using the recognition model obtained in the prior art, two pictures must be recognized separately by the recognition model, and recognition results of the two pictures are obtained respectively, and then the two recognition results are compared to determine whether there are differences in the corresponding areas in the two pictures. Obviously, this is also different from the solution described in the embodiment of the present disclosure that whether there are differences in the corresponding areas of the two pictures can be determined directly by using the trained recognition model.

Based on the above description, it can be seen that the training method provided in the embodiment of the present disclosure can obtain a recognition model, and the obtained recognition model can also recognize at a time whether there are differences in the commodity contents of the corresponding areas in the two adjacent pictures. As there is no need to compare and analyze recognition results, the recognition efficiency of the pictures is greatly improved, and operation steps are reduced; and as it does not need to compare and analyze the recognition results by a computer device, the performance requirements of the computer device are also reduced, thereby reducing the cost of the computer device.

By using the above method, the required recognition model can be quickly trained, and the recognition accuracy of the recognition model can also be guaranteed.

It is easy to understand that a precondition for collecting sales information in commodities of the cabinet is to know what on earth the commodity in the commodity area is (commodity information). For this reason, the present disclosure also provides a method for acquiring commodity information.

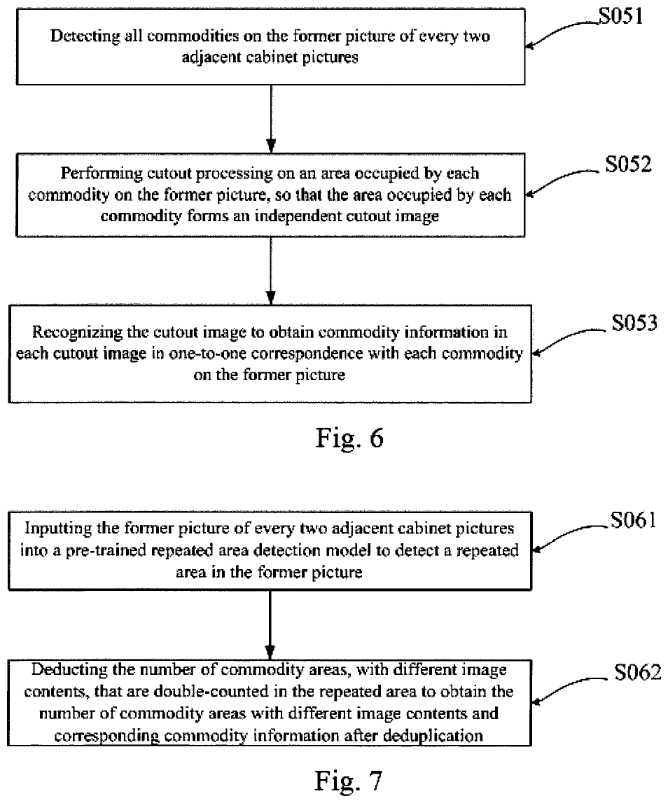

FIG. 6 illustrates preferred method steps for acquiring commodity information in the former picture of two adjacent cabinet pictures provided in an embodiment of the present disclosure.

In step S051 of the embodiment, all commodities on the former picture of every two adjacent cabinet pictures are detected.

The execution of step S051 may be implanted by a model capable of detecting commodities. Of course, the detection model may be obtained by using a training method in the prior art.

In step S052 of the embodiment, cutout processing is performed on an area occupied by each commodity on the former picture, so that the area occupied by each commodity forms an independent cutout image.

Based on the commodities detected in step S051, it is sufficient to determine the position and the occupied commodity area of each commodity in the picture. When the commodities in the pictures are detected, especially by using a commodity detection model for detection, closed areas (commodity areas) are always formed on edges of the commodities, and these areas are usually rectangular, so cutout processing may be performed on these rectangular areas. This is a relatively fast method and may be achieved by using artificial intelligence technology. Of course, a cutout model with relatively high precision may also be used to perform the cutout processing according to the outlines of the commodities.

In step S053 of the embodiment, the cutout image is recognized to obtain commodity information in each cutout image in one-to-one correspondence with each commodity on the former picture.

As the cutout image is cut out from the former picture, after the commodity information of the commodity in the cutout image is recognized, commodity information on the former picture may be obtained by using a positional relationship between the cutout image and the former picture. It can be seen that commodity information of each commodity on the former picture can be accurately obtained by the above solution.

As the height of a commodity area in a freezer is relatively large in an actual situation, it usually needs to arrange two cameras in an up-down direction to acquire pictures of the interior of the freezer (referred to as cabinet pictures in the present disclosure), wherein one camera is located near the top of the freezer, and the other is located near the bottom of the freezer. The fields of view of the two cameras overlap in the up-down direction, and the commodity area in the freezer can be covered after the fields of view are added together. In actual detection of commodities in the freezer, pictures in the two cameras (as pictures in the two cameras can reflect the complete commodity area in the freezer, pictures taken by the two cameras at the same time are usually detected as a whole (stitched into one picture)) are detected. However, since the fields of view of the two cameras have overlapped areas, a same commodity may appear twice. This will also affect the subsequent sales information of the commodity, resulting in inaccurate sales data acquired.

Furthermore, “the former picture” (one of the two adjacent pictures) can be used as a reference for the other of the two adjacent pictures. When the other picture shows the case that a commodity is taken away (sold), the position of the taken commodity can be known through comparison with the “former picture”. If the commodity information of all commodities in the former picture is recognized, the commodity information of the taken commodity can be known by comparison. However, when a repeated area appears in the former picture, if the other picture shows the case that a commodity just in the repeated area is taken away, the commodity will be counted twice, thereby affecting the accuracy of data finally obtained by using the method described in the present disclosure.

To improve the accuracy of the sales data and avoid the problem of repeated counting of commodities, the present disclosure also describes in another embodiment a solution for deducting repeated commodities. As shown in FIG. 7, FIG. 7 is a flow diagram of steps of a method for deducting repeated commodities provided in the embodiment.

As shown in FIG. 7, FIG. 7 is a flow diagram of preferred method steps for deducting double-counted commodities provided in the embodiment.

In step S061 of the embodiment, the former picture of every two adjacent cabinet pictures is input into a pre-trained repeated area detection model to detect a repeated area in the former picture.

Usually commodity placement areas in the freezer are all arranged in parallel in the horizontal direction, and the cameras are usually arranged in the vertical (up-down) direction, so when the pictures obtained by the two cameras are stitched, there will be a repeated area in the vertical direction (in different embodiments, the repeated area may be a commodity area of a single commodity, or may also be a combination of a plurality of commodity areas formed by a plurality of commodities). Thus, it only needs to find a repeated area in the horizontal direction. As indicated in step S061, the former picture may be input into the pre-trained repeated area detection model, and this repeated area detection model may be trained into a detection model specifically for detecting whether a row of commodity area in the picture (a set of all commodity areas in the same horizontal direction; it may also be understood as a commodity area formed by a plurality of commodities together, all of which are just in the same horizontal direction) is same as another row of commodity area. If a row of commodity area is same as another row of commodity area, then the two same commodity areas may be detected by the repeated area detection model, which lays the foundation for correct calculation of the quantity of commodities sold. Likewise, if the cameras are arranged in the horizontal (left-right) direction, a repeated area will appear in the horizontal direction. As the deduplication solution with the cameras arranged in the vertical direction may be used as a reference, the deduplication with the cameras in the horizontal direction will not be described in detail in the present disclosure.

In step S062, the number of commodity areas, with different image contents, that are double-counted in the repeated area is deducted to obtain the number of commodity areas with different image contents and corresponding commodity information after deduplication (repeated commodities are deducted).

After the repeated area is found, if an image content which is different from that in the corresponding commodity area in the other picture of the two adjacent pictures is present in the repeated area, obviously the image content is double-counted. For a picture formed by stitching two pictures, the same commodity area can only be repeated once at most, so this also provides a basis for deduction of the double-counted commodity information and quantity. After the repeated area is found in step S061, once there is commodity information in the repeated area, it is reasonable to believe that the (sales) quantity of the commodity information is double-counted, and it only needs to use half of the original quantity to obtain the actual quantity after deduplication. At this point, the deduction processing is accomplished efficiently by the above steps, and the accuracy of counting the quantity of sold commodities is improved.

Based on the above disclosure, it can be seen that in the method for collecting sales information of commodities in a cabinet provided by the present disclosure, the traditional method of manually collecting commodity sales information is changed to an automatic collection method, thereby greatly improving the collection efficiency of commodity sales information, and reducing manual labor intensity, and also dynamic changes of commodity sales can be known in real time.

On the other hand, the present disclosure can also provide reliable picture comparison data by different picture comparison methods, and accurately distinguish between different situations where commodities are for sale and where commodities are sold.

Finally, the present disclosure also provides a method for training an image recognition model, which can more effectively improve the recognition speed and accuracy of sales information of commodities on shelves and refrigerated cabinets.

### Exemplary Description of a System for Collecting Sales Information of Commodities in a Cabinet

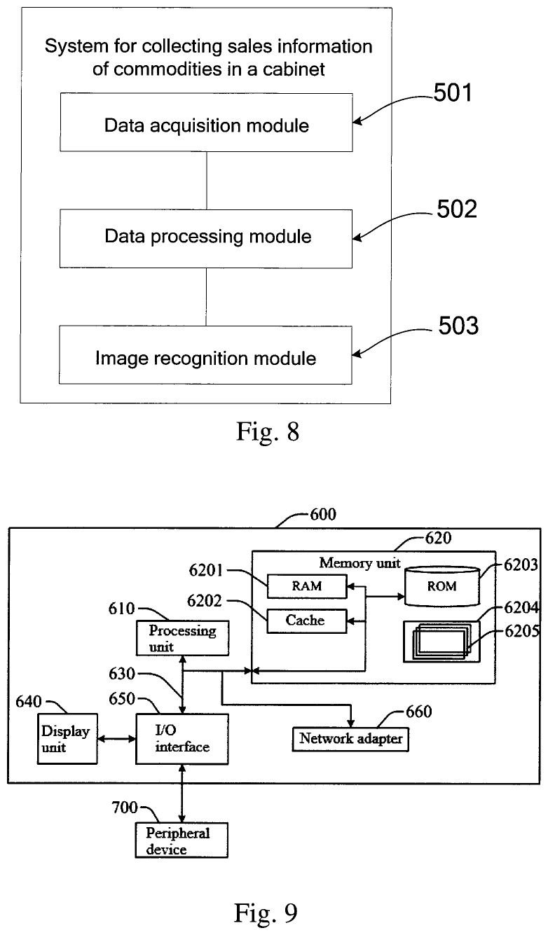

A system for collecting sales information of commodities in a cabinet is also provided in an embodiment of the present disclosure. FIG. 8 illustrates a modular connection diagram of a system for collecting sales information of commodities in a cabinet provided in an embodiment of the present disclosure. The system can implement the method for collecting sales information of commodities in a cabinet described in the present disclosure. To implement the method for collecting sales information of commodities in a cabinet described in the present disclosure, the system includes:

a data acquisition module 501 for successively acquiring pictures of the cabinet with the commodities placed therein in chronological order; and

acquiring commodity information on the former picture of every two adjacent cabinet pictures;

a data processing module 502 for successively adjusting every two adjacent cabinet pictures, so that photographing angles and positions of commodities in corresponding commodity areas of the two adjacent cabinet pictures are consistent; and

an image recognition module 503 for comparing the corresponding commodity areas in every two adjacent cabinet pictures after the adjustment to determine whether different image contents are present in the corresponding commodity areas; and

in the presence of different image contents, outputting the number of commodity areas with different image contents and corresponding commodity information.

### Exemplary Description of a Device for Collecting Sales Information of Commodities in a Cabinet

A device for collecting sales information of commodities in a cabinet is also provided in an embodiment of the present disclosure. The device includes:

a memory for storing a computer program; and

a processor for implementing the steps of the method for collecting sales information of commodities in a cabinet described in the present disclosure when executing the computer program.

Various aspects of the present disclosure may be embodied as a system, method or program product. Therefore, various aspects of the present disclosure may be specifically embodied in the form of an entirely hardware implementation, an entirely software implementation (including firmware, microcodes, etc.), or a hardware and software combined implementation, which may be collectively referred to herein as a “circuitry”, “module” or “platform”.

FIG. 9 is a structural diagram of a device for collecting sales information of commodities in a cabinet provided in an embodiment of the present disclosure. An electronic device 600 embodied according to the implementation in the embodiment will be described in detail below with reference to FIG. 9. The electronic device 600 shown in FIG. 9 is only an example, and should not impose any limitation on the function and application scope of any embodiment of the present disclosure.

As shown in FIG. 9, the electronic device 600 is embodied in the form of a general-purpose computing device. Components of the electronic device 600 may include, but are not limited to, at least one processing unit 610, at least one memory unit 620, and a bus 630 connecting different platform components (including the memory unit 620 and the processing unit 610), and a display unit 640.

The memory unit stores program codes, which may be executed by the processing unit 610 to cause the processing unit 610 to execute the implementation steps in the embodiment described in the above method section in the embodiment. For example, the processing unit 610 may execute the steps shown in FIGS. 1, 2, 3, 4, 5, 6 and 7.

The memory unit 620 may include a readable medium in the form of a volatile memory unit, such as a random access memory unit (RAM) 6201 and/or a cache memory unit 6202, and may further include a read only memory unit (ROM) 6203.

The memory unit 620 may further include a program/utility tool 6204 having a set of (at least one) program modules 6205. Such program modules 6205 include, but are not limited to, an operating system, one or more application programs, other program module(s) and program data. Each or some combination of the examples may include an implementation of a network environment.

The bus 630 may represents one or more of types of bus structures, including a memory unit bus or memory unit controller, a peripheral bus, an accelerated graphics port, a processing unit, or a local bus using any of types of bus structures.

The electronic device 600 may also communicate with one or more peripheral devices 700 (such as a keyboard, a pointing device and a Bluetooth device), and may also communicate with one or more devices that enable a user to interact with the electronic device 600, and/or communicate with any device (such as a router or a modem) that enables the electronic device to communicate with one or more other computing devices. Such communication can be performed through an input/output (I/O) interface 650. Moreover, the electronic device 600 may also communicate with one or more networks (such as a local area network (LAN), a wide area network (WAN), and/or a public network such as the Internet) through a network adapter 660. The network adapter 660 may communicate with other modules of the electronic device 600 through the bus 630. It should be understood that although not shown in the FIG. 9, other hardware and/or software modules can be used in combination with the electronic device 600, including but not limited to microcodes, a device driver, a redundant processing unit, an external disc drive array, and a RAID system, a magnetic tape drive, and a data backup storage platform.

### Exemplary Description of a Readable Storage Medium

An embodiment of the present disclosure also provides a computer readable storage medium storing a computer program which, when executed by a processor, can implement the steps of the method for collecting sales information of commodities in a cabinet in the present disclosure. Although other specific implementations are not exhaustively listed in the embodiment, in some possible implementations, various aspects described in the present disclosure may also be embodied in the form of a program product, which includes program codes configured to cause a terminal device to execute the steps of the implementations in the various embodiments of the present disclosure described in the section of the method for collecting sales information of commodities in a cabinet in the present disclosure, when the program product runs on the terminal device.

As described above, when the computer program stored in the computer readable storage medium provided in this embodiment is executed, the acquired two adjacent pictures are recognized and compared to determine whether there is a change in the image contents in the corresponding areas of the two pictures, to finally achieve the purpose of collecting sales information of the commodities in the cabinet.

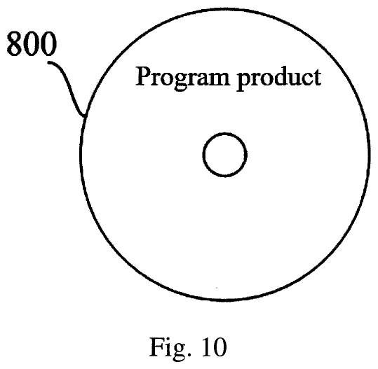

FIG. 10 is a structural diagram of a computer readable storage medium provided in an embodiment of the present disclosure. FIG. 10 shows a program product 800 for implementing the above method according to an implementation of the present disclosure, which may be a portable compact disk read only memory (CD-ROM) and include program codes, and may run on a terminal device such as a personal computer. Of course, the program product generated according to the embodiment is not limited thereto. In the present disclosure, the readable storage medium may be any tangible medium that contains or stores a program that can be used by or in combination with an instruction execution system, apparatus or device.

The program product may be one or any combination of readable media. The readable medium may be a readable signal medium or a readable storage medium. The readable storage medium may be, for example, but not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination thereof.

The computer readable storage medium may include a data signal propagated in a baseband or as part of a carrier wave, with readable program codes carried therein. The data signal so propagated may take various forms, including but not limited to an electromagnetic signal, an optical signal, or any suitable combination thereof. The readable storage medium may also be any readable medium other than a readable storage medium, and the readable medium can send, propagate or transmit a program to be used by or in combination with an instruction execution system, apparatus or device. The program codes contained in the readable storage medium may be transmitted by means of any appropriate medium, including but not limited to a wireless, wired, optical cable, or RF medium, or any suitable combination thereof.

The program codes for performing the operations of the present disclosure may be written in one or any combination of programming languages, the programming languages including an object-oriented programming language such as Java or C++, and also including a conventional procedural programming language, such as C language or similar programming language. The program codes may be executed entirely on a user's computing device, partly on a user's device, as an independent software package, partly on a user's computing device and partly on a remote computing device, or entirely on a remote computing device or server. In the case where a remote computing device is involved, the remote computing device may be connected to a user's computing device through any type of network, including a local area network (LAN) or wide area network (WAN), or may be connected to an external computing device (such as being connected through the Internet from an Internet service provider).

In summary, in the method, system and device for collecting sales information of commodities in a cabinet and a storage medium provided by the present disclosure, the traditional method of manually collecting commodity sales information is changed to an automatic collection method, thereby greatly improving the collection efficiency of commodity sales information, and reducing manual labor intensity, and also dynamic changes of commodity sales can be known in real time.

On the other hand, the present disclosure can also provide reliable picture comparison data by different picture comparison methods, and accurately distinguish between different situations where commodities are for sale and where commodities are sold.

Finally, the present disclosure also provides a method for training an image recognition model, which can more effectively improve the recognition speed and accuracy of sales information of commodities on shelves and refrigerated cabinets.

The above description is only description of preferred embodiments of the present disclosure, and does not limit the scope of the present disclosure in any way. All changes or modifications made by persons of ordinary skill in the art of the present disclosure based on the above disclosure fall within the protection scope of the claims.

1. A method for collecting sales information of commodities in a cabinet, comprising the following steps:
successively acquiring pictures of the cabinet with the commodities placed therein in chronological order;
acquiring commodity information on the former picture of every two adjacent cabinet pictures;
successively adjusting every two adjacent cabinet pictures, so that photographing angles and positions of commodities in corresponding commodity areas of the two adjacent cabinet pictures are consistent;
comparing the corresponding commodity areas in every two adjacent cabinet pictures after the adjustment to determine whether different image contents are present in the corresponding commodity areas; and
in the presence of different image contents, acquiring the number of commodity areas with different image contents and corresponding commodity information on the former picture.

2. The method for collecting sales information of commodities in a cabinet according to claim 1, wherein the step of successively adjusting every two adjacent cabinet pictures, so that photographing angles and positions of commodities in corresponding commodity areas of the two pictures are consistent comprises:
acquiring feature points on different commodities in the two adjacent cabinet pictures;
pairing the feature points in the two adjacent cabinet pictures to calculate a homography matrix; and
in the order of photographing time, performing a perspective transformation on the latter picture of the two pictures according to the homography matrix, to obtain two pictures in which the photographing angles and the positions of the commodities in the corresponding commodity areas are consistent.

3. The method for collecting sales information of commodities in a cabinet according to claim 1, wherein the step of successively adjusting every two adjacent cabinet pictures of a number of pictures, so that photographing angles and positions of commodities in corresponding commodity areas of the two pictures are consistent comprises:
in the order of photographing time, detecting commodities in the former picture of the two adjacent cabinet pictures to provide a first marker box for the commodities in the former picture;
using a template matching method, marking the latter picture with a second marker box corresponding to the first marker box;
using center points of the two corresponding marker boxes as corresponding feature points;
calculating a homography matrix by using the corresponding feature points; and
performing a perspective transformation on the latter picture of the two adjacent pictures by using the homography matrix to obtain two pictures in which the photographing angles and the positions of the commodities in the corresponding commodity areas are consistent.

4. The method for collecting sales information of commodities in a cabinet according to claim 1, wherein the step of comparing the corresponding commodity areas in every two adjacent cabinet pictures after the adjustment to determine whether different image contents are present at positions in the corresponding commodity areas comprises:
performing channel dimension stacking on every two adjacent cabinet pictures after the adjustment to obtain an image matrix in which the corresponding commodity areas coincide; and
inputting the image matrix into a recognition model capable of recognizing image contents of the corresponding commodity areas in the image matrix, to detect commodity areas with different contents.

5. The method for collecting sales information of commodities in a cabinet according to claim 4, wherein a method for training the recognition model comprises the following steps:
successively acquiring, in chronological order, a plurality of simulated pictures that simulate changes in the sales of the commodities in the cabinet;
successively adjusting every two adjacent pictures of the plurality of simulated pictures, so that photographing angles and positions of commodities in corresponding commodity areas of the two pictures are consistent;
performing marking in the former picture arranged in chronological order of every two adjacent simulated pictures after the adjustment to mark an area where a sold commodity is simulated;
performing channel dimension stacking on every two adjacent simulated pictures after the marking to obtain a simulated image matrix in which the corresponding commodity areas coincide; and
training a model by using the simulated image matrix to obtain a recognition model capable of recognizing image contents of the corresponding commodity areas.

6. The method for collecting sales information of commodities in a cabinet according to claim 1, wherein the step of acquiring commodity information on the former picture of every two adjacent cabinet pictures comprises:
detecting all commodities on the former picture of every two adjacent cabinet pictures;
performing cutout processing on an area occupied by each commodity on the former picture, so that the area occupied by each commodity forms an independent cutout image; and
recognizing the cutout image to obtain commodity information in each cutout image in one-to-one correspondence with each commodity on the former picture.

7. The method for collecting sales information of commodities in a cabinet according to claim 1, wherein the method further comprises:
inputting the former picture of every two adjacent cabinet pictures into a pre-trained repeated area detection model to detect a repeated area in the former picture; and
deducting commodity information and quantity that are double-counted in the repeated area to obtain the number of commodity areas with different image contents and corresponding commodity information after deduplication.

8. A system for collecting sales information of commodities in a cabinet, for implementing the steps of the method for collecting sales information of commodities in a cabinet according to claim 1, wherein the system comprises:
a data acquisition module for successively acquiring pictures of the cabinet with the commodities placed therein in chronological order; and
acquiring commodity information on the former picture of every two adjacent cabinet pictures;
a data processing module for successively adjusting every two adjacent cabinet pictures, so that photographing angles and positions of commodities in corresponding commodity areas of the two adjacent cabinet pictures are consistent; and
an image recognition module for comparing the corresponding commodity areas in every two adjacent cabinet pictures after the adjustment to determine whether different image contents are present in the corresponding commodity areas; and
in the presence of different image contents, outputting the number of commodity areas with different image contents and corresponding commodity information on the former picture.

9. A device for collecting sales information of commodities in a cabinet, comprising:
a memory for storing a computer program; and
a processor for implementing the steps of the method for collecting sales information of commodities in a cabinet according to claim 1 when executing the computer program.

10. A computer readable storage medium, wherein the computer readable storage medium stores a computer program which, when executed by a processor, implements the steps of the method for collecting sales information of commodities in a cabinet according to claim 1.
